(19) United States
(12) Patent Application Publication
(10) Pub. No.: US 2012/0265887 A1
(43) Pub. Date: Oct. 18, 2012

(54) COMMUNICATION APPARATUS, PROCESSING METHOD THEREOF, NON-TRANSITORY COMPUTER-READABLE STORAGE MEDIUM, AND COMMUNICATION SYSTEM

(75) Inventor: Fumihide Goto, Naka-gun (JP)

(73) Assignee: CANON KABUSHIKI KAISHA, Tokyo (JP)

(21) Appl. No.: 13/419,112

(22) Filed: Mar. 13, 2012

(30) Foreign Application Priority Data
Apr. 14, 2011 (JP) 2011-090405

(51) Int. Cl. G06F 15/16

(52) U.S. Cl. 709/228

(57) ABSTRACT

A communication apparatus detects one or a plurality of apparatuses which have been instructed to start communication-parameter setting processing using identification information and, moreover, in which this identification information has already been set, outputs terminal identification information, and executes the communication-parameter setting processing with an apparatus, which is other than an apparatus detected before the terminal identification information is output, from among detected apparatuses.

### BACKGROUND OF THE INVENTION

1. Field of the Invention

The present invention relates to a communication apparatus, a processing method thereof, a non-transitory computer-readable storage medium and a communication system.

2. Description of the Related Art

Wireless communication typified by a wireless LAN compliant with the IEEE 802.11 standard series is known in the art. In such wireless communication, there are a large number of settings that must be made before communication is carried out. For example, at the time of communication, communication parameters such as an SSID (Service Set Identifier), which is used as a network identifier, an encryption method, an encryption key, an authentication method and an authentication key are required to be set as setting items. Manually inputting all of these settings is a very complicated operation for the user.

In order to deal with such a complicated operation, WPS (Wi-Fi Protected Service) has been standardized as an industrial-standard automatic setting method for setting communication parameters in simple fashion. An example of automatic setting of communication parameters by WPS has been disclosed in “Wi-Fi CERTIFIED™ for Wi-Fi Protected Setup: Easing the User Experience for Home and Small Office Wi-Fi Networks, http://www.wi-fi.org/wp/wifi-protected-setup”.

In the above-mentioned technology, an access point (base station) or any apparatus that is capable of communicating with an access point serves as an apparatus that is a provider of communication parameters (such an apparatus will be referred to as a “providing apparatus” below). An apparatus on the receiving side of communication parameters (this apparatus will be referred to as a “receiving apparatus” below) is connected to the access point temporarily and receives communication parameters from the providing apparatus. According to WPS, the providing apparatus and the receiving apparatus are referred to as a “registrar” and an “enrollee”, respectively.

A method employing terminal identification information [for example, information referred to as a PIN (Personal Identification Number)] for identifying an apparatus is known as one WPS method. According to this method, terminal identification information generated by an enrollee is registered with a registrar. In this way the sending and receiving and setting of settings information that enables communication in accordance with the above-mentioned standard are carried out automatically and a connection between both apparatuses is established. In relation to this technology, a technique concerning the registration of terminal identification information when wireless LAN settings are performed has been disclosed in the specification of Japanese Patent Laid-Open No. 2008-219457.

With regard to the above-mentioned terminal identification information (PIN code), there are two cases, namely a case where the information is assigned to an apparatus intrinsically and a case where the information is generated whenever communication-parameter setting processing is executed. In particular, in a case where an apparatus has not been provided with a rich user interface, often terminal identification information is assigned fixedly and this fixed terminal identification information is affixed to the surface of an apparatus as by a seal or the like.

When there are multiple providing apparatuses in a case where communication parameters are set by a method using the above-mentioned terminal identification information, the receiving apparatus must try to connect to each of these multiple providing apparatuses.

In processing for setting communication parameters, generally the receiving apparatus searches for a providing apparatus after the receiving apparatus generates the terminal identification information. At such time the receiving apparatus will try to connect itself even to a providing apparatus in which terminal identification information that is clearly different from that of the receiving apparatus has been set.

### SUMMARY OF THE INVENTION

The present invention provides a technique for curbing unnecessary trial connection of a receiving apparatus to a providing apparatus at the time of processing for setting communication parameters.

According to a first aspect of the present invention there is provided a communication apparatus comprising: a detection unit configured to detect one or a plurality of apparatuses which have been instructed to start communication-parameter setting processing using identification information and, moreover, in which this identification information has already been set; an output unit configured to output terminal identification information; and a setting control unit configured to execute the communication-parameter setting processing with an apparatus, which is other than an apparatus detected before the terminal identification information is output by the output unit, from among apparatuses detected by the detection unit.

According to a second aspect of the present invention there is provided a communication system including a providing apparatus configured to provide communication parameters, and a receiving apparatus configured to execute communication-parameter setting processing with the providing apparatus and receive the communication parameters; wherein when identification information has already been set, the providing apparatus transmits a signal inclusive of additional information indicative of this fact in a case where the start of communication-parameter setting processing using the identification information has been instructed; and the receiving apparatus comprises: a detection unit configured to detect, based upon receipt of the signal, one or a plurality of providing apparatuses which have been instructed to start communication-parameter setting processing using identification information and, moreover, in which this identification information has already been set; an output unit configured to output terminal identification information; and a setting control unit configured to execute the communication-parameter setting processing with a providing apparatus, which is other than an apparatus detected before the terminal identification information is output by the output unit, from among providing apparatuses detected by the detection unit.

According to a third aspect of the present invention there is provided a processing method of a communication apparatus, comprising: detecting one or a plurality of already set apparatuses which have been instructed to start communication-parameter setting processing using identification information and, moreover, in which this identification information has already been set; outputting terminal identification information; and executing the communication-parameter setting processing with an already set apparatus other than an already set apparatus detected before the terminal identification information is output.

According to a fourth aspect of the present invention there is provided a non-transitory computer-readable storage medium storing a computer program for causing a computer, which is incorporated in a communication apparatus, to function as: a detection unit configured to detect one or a plurality of already set apparatuses which have been instructed to start communication-parameter setting processing using identification information and, moreover, in which this identification information has already been set; an output unit configured to output terminal identification information; and a setting control unit configured to execute the communication-parameter setting processing with an already set apparatus other than an already set apparatus detected before the terminal identification information is output by the output unit.

According to a fifth aspect of the present invention there is provided a communication apparatus comprising: a detection unit configured to detect one or a plurality of already set apparatuses which have been instructed to start communication-parameter setting processing using identification information and, moreover, in which this identification information has already been set; an output unit configured to output terminal identification information; and a setting control unit configured to execute the communication-parameter setting processing preferentially with an already set apparatus other than an already set apparatus detected before the terminal identification information is output by the output unit

Further features of the present invention will be apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a diagram illustrating an example of the overall configuration of a communication system according to an embodiment of the present invention;

FIG. 2 is a diagram illustrating an example of the hardware configuration of a station 35 shown in FIG. 1;

FIG. 3 is a diagram illustrating a functional configuration implemented by a control unit 12 of station 35;

FIG. 4 is a sequence chart illustrating an example of the flow of processing of the communication system shown in FIG. 1; and

FIG. 5 is a flowchart illustrating an example of the flow of processing executed by the station 35 shown in FIG. 1.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

(First Embodiment)

A communication apparatus according to this embodiment of the present invention will be described in detail with reference to the drawings. Although an example using a wireless LAN system compliant with the IEEE 802.11 series will be described below, the form of communication is not necessarily limited to a wireless LAN compliant with IEEE 802.11.

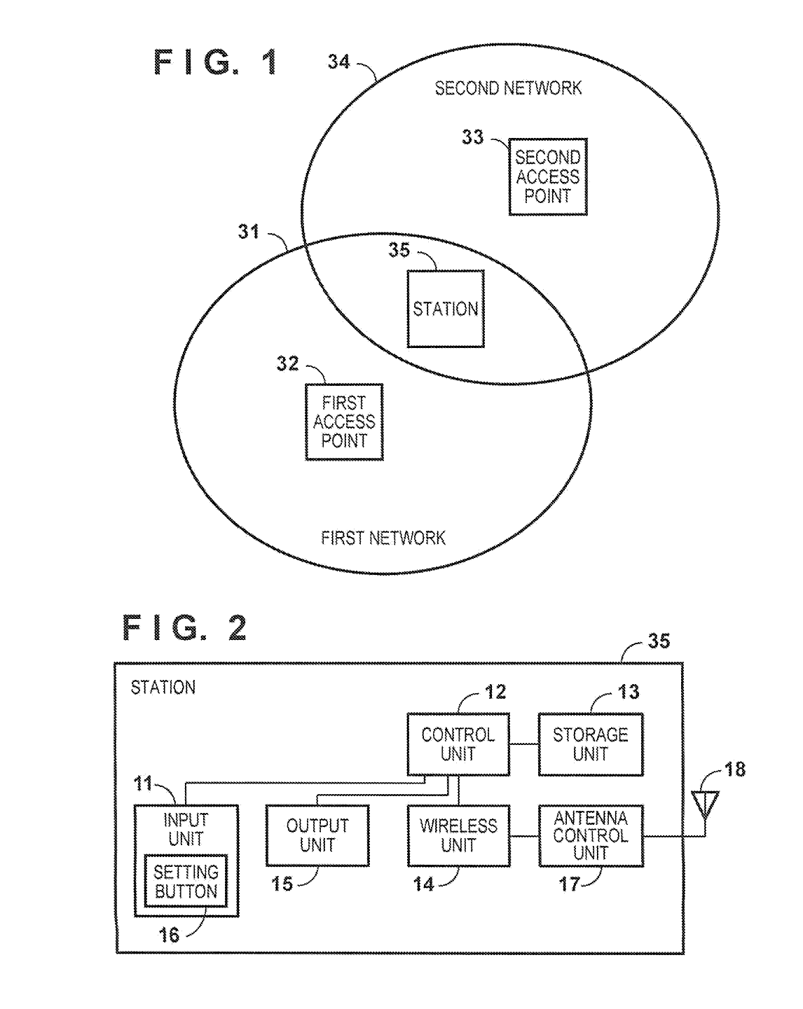

FIG. 1 is a diagram illustrating an example of the overall configuration of a communication system according to an embodiment of the present invention.

The communication system includes a first access point 32, a second access point 33 and a station 35.

The first access point 32 constructs a first network 31 and functions as an apparatus for managing this network. The second access point 33 constructs a second network 34 and functions as an apparatus for managing this network. The station 35 is connectable to either the first network 31 or the second access point 33.

At the time of processing for setting communication parameters, the first access point 32 or second access point 33 serves as an apparatus (providing apparatus) that is a provider of the communication parameters, and the station 35 becomes an apparatus (receiving apparatus) that receives these parameters. That is, the first access point 32 and second access point 33 correspond to registrars in WPS and the station 35 corresponds to an enrollee in WPS.

The first access point 32, second access point 33 and station 35 support processing for setting communication parameters using a PIN code. With processing for setting communication parameters using a PIN code, identification information (a PIN code) is set beforehand on the side of the access point, and the access point provides communication parameters to the station having the PIN code that matches this identification information.

It should be noted that, in a case where the first access point 32 is the providing apparatus, the station 35 sends the first access point 32 information necessary for it to join the first network 31. In response, the station 35 receives the provision of the communication parameters from the first access point 32. Similarly, in a case where the second access point 33 is the providing apparatus, the station 35 sends the second access point 33 information necessary for it to join the second network 34. In response, the station 35 receives from the second access point 33 the provision of the communication parameters.

The foregoing is a description of one example of the overall configuration of a communication system. It should be noted that the configuration of the communication system shown in FIG. 1 is strictly one example and the system is not limited to this configuration. For instance, the first access point 32, second access point 33 and station 35 may each just as well be implemented as a dual terminal having the functions of both an access point and station, by way of example.

Next, reference will be had to FIG. 2 to describe an example of the hardware configuration of the station 35 shown in FIG. 1.

The station 35 comprises, as hardware components, an input unit 11, a control unit 12, a storage unit 13, a wireless unit 14, an output unit 15, an antenna control unit 17 and an antenna 18.

The control unit 12 is implemented by, e.g., a CPU (Central Processing Unit) or the like and exercises overall control of each of the above-mentioned components. The control unit 12 controls also the setting of communication parameters between this station and another apparatus.

The storage unit 13 is implemented by, e.g., a RAM (Random-Access Memory), a ROM (Read-Only Memory) or an external storage device (e.g., a memory card) or the like and stores various information. By way of example, a control program and communication parameters and the like are stored in the storage unit 13. Various operations in the station 35 are carried out by having the control unit 12 execute the control program that has been stored in the storage unit 13.

The antenna control unit 17 controls the antenna 18. The wireless unit 14 performs wireless communication via the antenna control unit 17 and antenna 18. The wireless unit 14 implements wireless LAN (Local-Area Network) communication compliant with the IEEE 802.11 series, by way of example.

The output unit 15 is implemented by, e.g., an LCD (Liquid Crystal Display) or LEDs (Light-Emitting Diodes) and speaker, etc., and outputs various information to the user. Specifically, the output unit 15 produces an output of visually recognizable visual information in the manner of an LCD or LEDs, and an output of audio information using a speaker or the like. It should be noted that it will suffice if the output unit 15 is capable of outputting at least either of visual information and audio information.

The input unit 11 is implemented by, e.g., a touch-sensitive panel and buttons or the like and inputs instructions from the user. The input unit 11 is provided with a setting button 16 for issuing an instruction that triggers the start of processing for setting communication parameters. For example, when the setting button 16 is operated by the user, processing for setting (automatically) communication parameters starts.

The foregoing is a description of one example of the hardware configuration of the station 35. It should be noted that the first access point 32 and second access point 33 also incorporate computers, although a description thereof based on the drawings is omitted. That is, the access points 32 and 33 have a hardware configuration similar to that of the station 35.

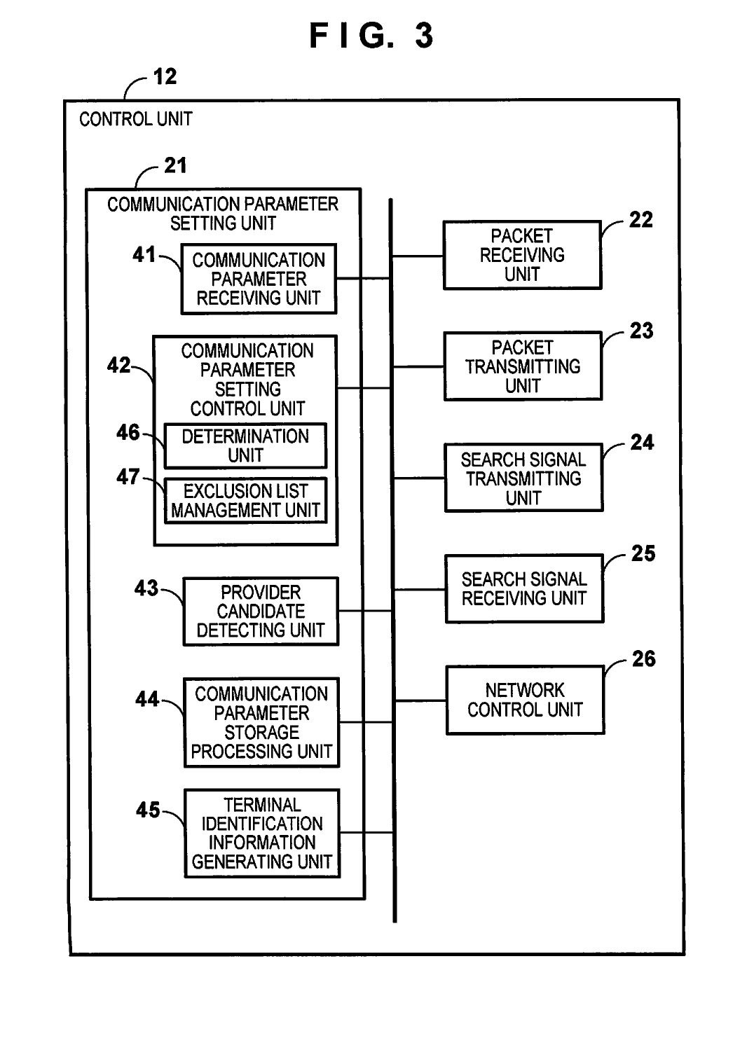

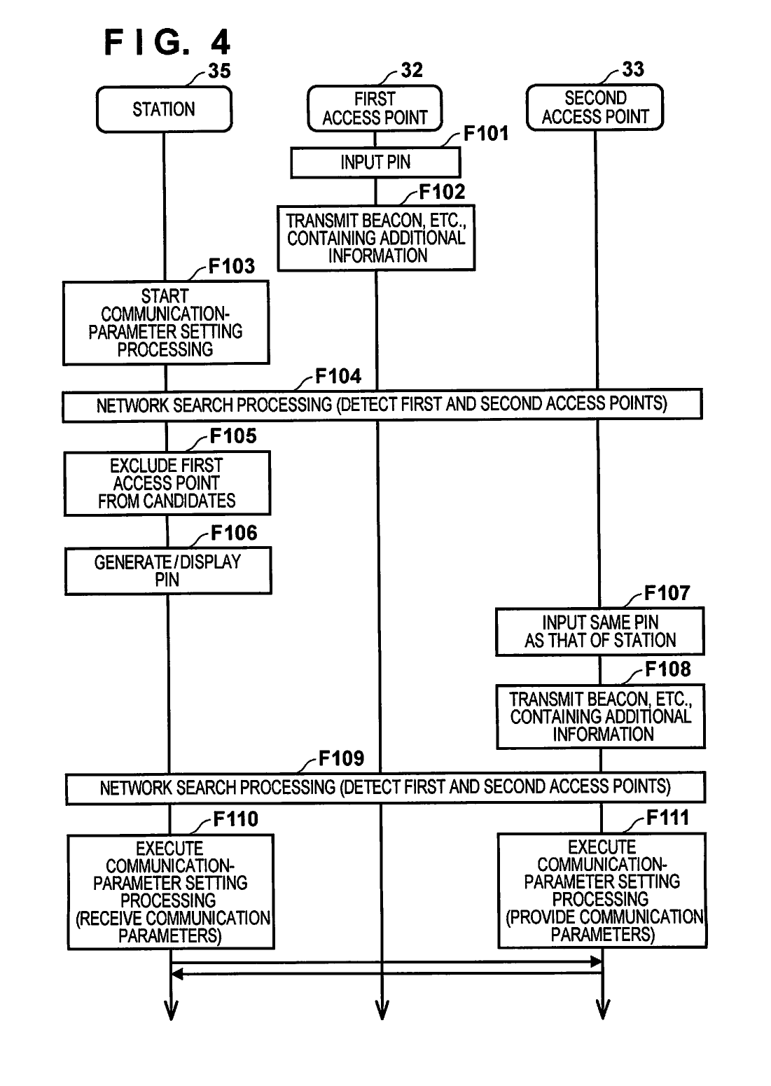

Next, reference will be had to FIG. 3 to describe an example of a functional configuration implemented by the control unit 12 of station 35. Each of the components in the control unit 12 is implemented by having a CPU read out and execute a program that has been stored in a ROM or the like. It should be noted that it is permissible as a matter of course for some or all of the components in the control unit 12 to be implemented by dedicated hardware.

The control unit 12 comprises, as functional components, a communication parameter setting unit 21, a packet receiving unit 22, a packet transmitting unit 23, a search signal transmitting unit 24, a search signal receiving unit 25 and a network control unit 26. Here the description will emphasize the components concerning processing for setting communication parameters necessary in order to carry out wireless LAN communication. It should be noted that the communication parameters necessary for carrying out wireless LAN communication are a network identifier (SSID), an encryption method (it may be called encryption type, encryption scheme or encryption algorithm), an encryption key, an authentication method (it may be called authentication type, authentication scheme or authentication algorithm) and an authentication key, etc. This illustration is strictly one example and the communication parameters may include other information as a matter of course.

The packet receiving unit 22 controls the receipt of packets relating to various communication. The packet receiving unit 22 controls the receipt of a beacon (annunciation signal), by way of example. The packet transmitting unit 23 controls the transmission of packets relating to various communication. The packet transmitting unit 23 controls the transmission of a beacon, by way of example. It should be noted that various information concerning the apparatus at the source of transmission is added to the beacon.

The search signal transmitting unit 24 controls the transmission of a search signal (a probe request, for example). It should be noted that a probe request performs the function of a network search signal for the purpose of finding a desired network. Further, in a case where it has received a probe request, the search signal transmitting unit 24 also controls transmission of a probe response as the response to the request.

The search signal receiving unit 25 controls the receipt of a search signal (a probe request, for example) from another apparatus. The search signal receiving unit 25 further receives a probe response. Various information relating to the apparatus at the source of transmission is added to the search signal and its response signal.

The network control unit 26 controls the network connection. More specifically, the network control unit 26 executes processing such as processing for connecting to a wireless LAN.

The communication parameter setting unit 21 executes processing for setting (automatically) the communication parameters. The communication parameter setting unit 21 is provided with a communication parameter receiving unit 41, a communication parameter setting control unit 42, a provider candidate detecting unit 43, a communication parameter storage processing unit 44 and a terminal identification information generating unit 45.

The terminal identification information generating unit 45 generates terminal identification information (a PIN code) for identifying its own apparatus. The PIN code is generated as a random value whenever processing for setting communication parameters is executed. The provider candidate detecting unit 43 detects a candidate for an apparatus (providing apparatus) that will be the source of provision of communication parameters. Detection of a providing apparatus is carried out based upon transmission of a search signal and the response thereto performed by the search signal transmitting unit 24 and search signal receiving unit 25. It should be noted that detection of a providing apparatus candidate may also be performed based upon receipt of a beacon by the packet receiving unit 22. In a case where provision of communication parameters is to be received from the providing apparatus, the station 35 requests this providing apparatus for provision of the communication parameters and then receives provision of the communication parameters. In the description that follows, there will also be instances where the apparatus that receives provision of communication parameters is referred to as a “receiving apparatus”.

The communication parameter receiving unit 41 receives communication parameters from the apparatus that is the communicating party. The communication parameter setting control unit 42 exercises overall control of processing relating to the communication parameters. For example, the communication parameter setting control unit 42 controls various protocols in processing for setting communication parameters. In addition, the communication parameter setting control unit 42 also determines whether time that has elapsed from the start of processing for setting communication parameters has exceeded a predetermined time (a time limit on processing for setting communication parameters). If it determines that the predetermined time has been exceeded, the communication parameter setting control unit 42 suspends the processing for setting communication parameters.

The communication parameter setting control unit 42 is provided with a determination unit 46 and an exclusion list management unit 47. From one or a plurality of providing apparatus candidates detected by the provider candidate detecting unit 43, the determination unit 46 determines a providing apparatus that matches a predetermined condition. Using the storage unit 13, the exclusion list management unit 47 manages an exclusion list in which apparatuses excluded from the providing apparatus candidates are registered. For example, the exclusion list management unit 47 registers apparatuses in the exclusion list and deletes apparatuses from the list.

The communication parameter storage processing unit 44 stores communication parameters, which have been received by provision from the providing apparatus, in the storage unit 13. In this embodiment, when provision of communication parameters has been received from another apparatus, these communication parameters are stored in the storage unit 13 as already set parameters. Already set parameters that have been stored in the storage unit 13 may be discarded at the end of communication in the network constructed using these already set parameters. Further, after being stored in the storage unit 13, the already set parameters may discarded as when the apparatus power supply is turned off upon elapse of a fixed period of time. Alternatively, the already set parameters may be retained semipermanently as long as there is no explicit instruction to delete them.

Next, reference will be had to FIG. 4 to describe an example of the flow of processing in the communication system shown in FIG. 1. Described will be an example of the flow of processing in a case where the station 35 executes processing with an access point for setting communication parameters by a method using terminal identification information (a PIN code).

First, the terminal identification information (a PIN code) is input at the first access point 32 (step F101). The first access point 32 then transmits a beacon or probe response (step F102). At this time the beacon or probe response contains additional information indicating that processing for setting communication parameters has already started. That is, if setting of a PIN code has already been performed in the providing apparatus in processing for setting communication parameters using a PIN code, then the apparatus incorporates the above-mentioned additional information in the beacon or response and transmits the beacon or response.

It should be noted that, in WPS, information indicating that processing for setting communication parameters has already started means that “1” has been set as a selected-registrar flag, by way of example. In the method using a PIN code, the selected-registrar flag is “1” only in a case where a PIN code has already been set in the providing apparatus. As a consequence, the state attained is one in which the processing at step F102 notifies surrounding apparatuses of the fact that the PIN code has already been set.

Accordingly, the station 35 starts processing for setting communication parameters using the terminal identification information (step F103). When this processing starts, the station 35 first executes search processing for finding a network (step F104). In network search processing, an apparatus (the first access point 32) that has already started processing for setting communication parameters and an apparatus (the second access point 33) that has not yet started processing for setting communication parameters are detected. At this time whether or not the detected access point has started processing for setting communication parameters can be determined based upon the above-mentioned additional information.

In a case where the PIN code in station 35 is variable (that is, a case where the PIN code has a different value every time processing for setting communication parameters is executed), a PIN code will not have been generated in the station 35 and notification thereof will not have been given (not displayed) at the timing at which the processing of step F104 is executed. Consequently, the probability that a PIN code that has already been set in the first access point 32 will match the PIN code of the station 35 is extremely low. The reason for this is that, since the PIN code has eight digits and the final single digit is a check sum, the likelihood that PIN codes will accidentally be identical is 1/10⁷. In a case where a variable PIN code is utilized, therefore, the station 35 will exclude the first access point 32 detected at the timing of step F104 (namely the apparatus that has already started processing for setting communication parameters) from candidates for providing apparatuses that execute processing for setting communication parameters (step F105).

Next, in order to execute processing for setting communication parameters started at step F103, the station 35 generates a PIN code internally and outputs the PIN code to a user interface such as the output unit 15 (step F106).

Upon referring to the PIN code, which is displayed on the output unit 15 of station 35, the user inputs the PIN code (step F107) to the second access point 33 via an input unit (not shown). Owing to input of the PIN code, the second access point 33 launches processing for setting communication parameters. Then, in a manner similar to that of the first access point 32, the second access point 33 transmits a beacon or probe response upon incorporating information indicating that processing for setting communication parameters has already started (step F108).

After the processing for generating and displaying the PIN code at step F105, the station 35 again executes network search processing (step F109). Since the first access point 32 detected at the timing of the processing of step F104 was excluded, at this time the station 35 executes processing for setting communication parameters between itself and the second access point 33 (steps F110, F111). Specifically, communication parameters are provided from the second access point 33 and the station 35 receives and sets these provided communication parameters.

It should be noted that if the PIN code in the station 35 is fixed, then a match between the PIN code of station 35 and the PIN code of first access point 32 is fully possible even at the timing of the processing of step F104. The reason is that, by way of example, it is possible for the user to refer to the PIN code affixed to the surface of the station 35 as by a seal and to input the PIN code to the first access point 32. In this case, it is unnecessary to exclude the first access point 32 by the processing of step F105 and the first access point 32 also becomes a candidate for a providing apparatus of processing for setting communication parameters. Therefore, it may be arranged so that, if the PIN code in station 35 is fixed, processing for setting communication parameters is executed at the moment (step F104) the station 35 detects that the first access point 32 has already started processing for setting the communication parameters.

Further, in the processing of step F109, the station 35 detects that both the first access point 32 and second access point 33 have already started processing for setting communication parameters. At this time the station 35 may just as well try executing processing for setting communication parameters alternatingly with the first access point 32 and with the second access point 33.

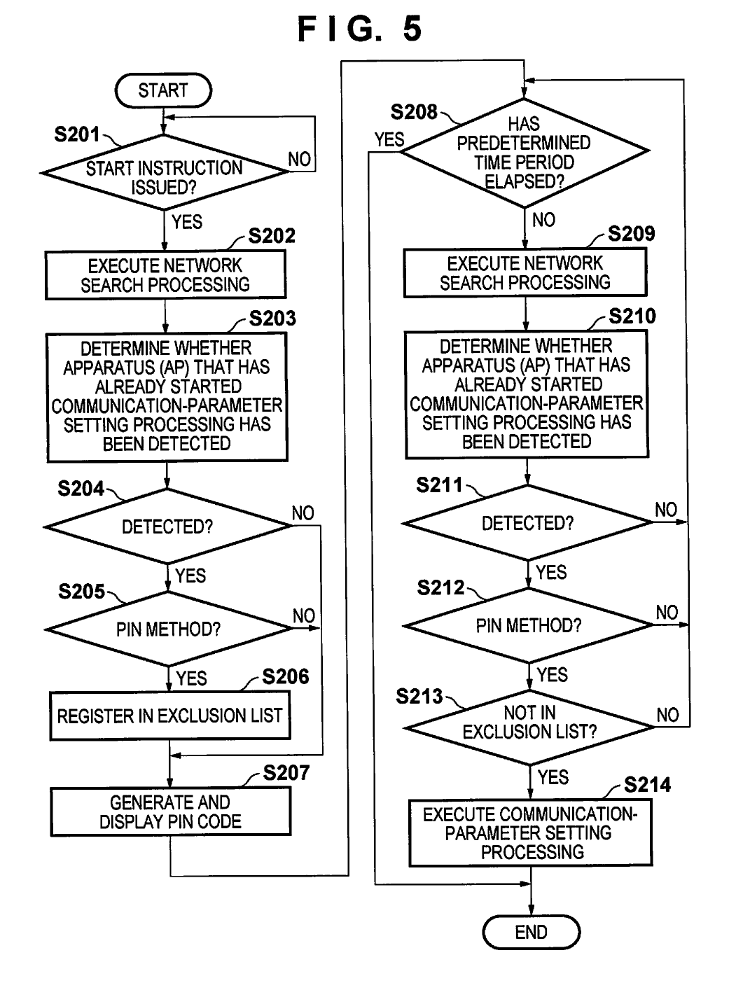

Next, reference will be had to FIG. 5 to describe an example of processing in the station 35 shown in FIG. 1.

This processing starts when an instruction to start processing for setting communication parameters according to the PIN code method is issued by the user (“YES” at step S201). By way of example, the instruction to start processing for setting communication parameters is issued in response to the user pressing the setting button 16 provided on the station 35.

When this processing starts, the station 35 first executes network search processing by using the provider candidate detecting unit 43 (step S202). In this processing, the station 35 receives a beacon, for example, transmitted from another apparatus. Further, the station 35 conducts active scanning and broadcasts a probe request, after which is receives a probe response from the access point.

Using the provider candidate detecting unit 43, the station 35 determines whether it has received a signal (beacon or probe request) that contains additional information indicating that processing for setting communication parameters has already started. Specifically, the station 35 determines whether an access point that has already started processing for setting communication parameters has been detected (step S203). In WPS, as mentioned above, a beacon and probe response will contain predetermined additional information if processing for setting communication parameters has started at an access point. If a selected registrar has been set in the probe response and this information flag is logical “1”, then the station 35 will determine that an access point that has already started processing for setting communication parameters has been detected. It should be noted that although a concrete example regarding WPS has been described, this does not impose any limitation. It will suffice if it can be determined whether processing for setting communication parameters has already started at an access point or whether a PIN code has already been set at an access point; any method may be used.

If the result of the determination is that such as access point cannot be detected (“NO” at step S204), then the station 35 uses the terminal identification information generating unit 45 to generate a PIN code and to display the generated PIN code on the output unit 15 (step S207).

On the other hand, if an access point is detected (“YES” at step S204), then the station 35 uses the determination unit 46 to determine the method of processing for setting communication parameters. If the pertinent access point is implementing a method other than a PIN method (“NO” at step S205), the station 35 executes the processing of step S207 described above.

Further, if this access point is implementing the PIN method (“YES” at step S205), the station 35 uses the exclusion list management unit 47 to register this access point in the exclusion list (step S206). That is, this access point is excluded from candidates for processing for setting communication parameters.

On the other hand, if the result of the determination made at step S205 is that the pertinent access point is not implementing the PIN method (“NO” at step S205), then the station 35 executes the processing of step S207 described above.

After the PIN code is displayed on the output unit 15, the station 35 uses the communication parameter setting control unit 42 to determine whether a predetermined period of time has elapsed from the start instruction of step S201. It should be noted that the predetermined period of time is indicative of a time limit in terms of protocol specifications in processing for setting communication parameters.

If the predetermined time period has elapsed (“YES” at step S208), the station 35 terminates this processing. At this time the station 35 may present a timeout error display or the like on the output unit 15.

On the other hand, if the predetermined time period has not elapsed (“NO” at step S208), then the station 35 executes network search processing (step S209) and searches for an access point that satisfies the above-mentioned condition (step S210) in a manner similar to that of the processing of steps S202 and S203.

If the result of the processing at step S210 is that such an access point can be detected (“YES” at step S211), then, in a manner similar to that of the processing at step S205, the station 35 determines whether this access point is implementing the PIN method. If it is implementing the PIN method (“YES” at step S212), then the station 35 further determines whether this access point has been registered in the exclusion list.

If the result of this determination is that this access point has not been registered in the exclusion list (“YES” at step S213), then the station 35 uses the communication parameter setting control unit 42 to execute processing for setting communication parameters between itself and this access point (step S214). That is, the station 35 receives communication parameters from an access point other than the apparatuses that have been registered in the exclusion list and sets these parameters, after which the station terminates this processing.

It should be noted that in a case where the result of the processing of step S210 is that the pertinent access point could not be detected (“NO” at step S211) and in a case where the pertinent access point is implementing a method other than the PIN method (“NO” at step S212), the station 35 returns to the processing of step S208. Also in a case where the pertinent access point has been registered in the exclusion list (“NO” at step S213), the station 35 returns to the processing of step S208.

The foregoing is a description regarding an example of the flow of processing executed in the station 35. It should be noted that in the processing of step S206, it will suffice if an access point that has been registered in the exclusion list is deleted from the exclusion list at the timing at which processing for setting communication parameters ends normally or at a timing at which processing for setting communication parameters is started afresh. In addition, deletion may be performed at a timing at which the value of the selected-registrar flag of an access point that has been registered in the exclusion list has transitioned to a value other than “1”.

Further, in the description rendered above, an access point is registered in the exclusion list by the processing of step S206. However, this processing need be executed only in a case where the PIN code of station 35 is variable. That is, if the PIN code is fixed, registration of the access point in the exclusion list is not carried out.

In the foregoing description, an access point that has been registered in the exclusion list is excluded from among those that execute processing for setting communication parameters. However, it may be arranged so that processing for setting communication parameters is executed preferentially with an access point that has not been registered in the exclusion list. In other words, processing for setting communication parameters is executed with an access point that has not been registered in the exclusion list from among detected access points executing the PIN method. It may be arranged so that in the event that processing with all access points that have not been registered in the exclusion list fails, the processing for setting communication parameters is executed with regard to an access point that has been registered in the exclusion list.

In accordance with this embodiment, as described above, it is possible to suppress, prior to display of a PIN code, trials of processing for setting communication parameters with respect to access points that have already started processing for setting communication parameters based upon the PIN method. As a result, processing for setting communication parameters is no longer executed unnecessarily and needless network traffic can be reduced, by way of example.

The foregoing is an example of a typical embodiment. However, the present invention is not limited to the embodiment described above and illustrated in the drawings. The present invention can be worked upon being suitably modified within limits that do not depart from the gist of the present invention.

In the description rendered above, the invention is described taking as an example a case utilizing a wireless LAN (wireless LAN network) compliant with IEEE 802.11, by way of example. However, this does not impose any limitation. For example, it is permissible to use other wireless media such as a wireless USB (Universal Serial Bus), MBOA (Multi-Band OFDM Alliance), Bluetooth (registered trademark), UWB (Ultra-Wide Band) and ZigBee. Furthermore, a communication medium utilizing a wired scheme such as a wired LAN may also be used. It should be noted that MBOA and UWB include wireless USB, wireless 1394 and WINET, etc.

(Other Embodiments)

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-090405, filed on Apr. 14, 2011, which is hereby incorporated by reference herein in its entirety.

What is claimed is:

1. A communication apparatus comprising:
a detection unit configured to detect one or a plurality of apparatuses which have been instructed to start communication-parameter setting processing using identification information and, moreover, in which this identification information has already been set;
an output unit configured to output terminal identification information; and
a setting control unit configured to execute the communication-parameter setting processing with an apparatus, which is other than an apparatus detected before the terminal identification information is output by said output unit, from among apparatuses detected by said detection unit.

2. The communication apparatus according to claim 1, wherein when identification information has already been set, said apparatus transmits a signal inclusive of additional information indicative of this fact in a case where the start of communication-parameter setting processing using the identification information has been instructed; and
said detection unit detects a candidate for the communication-parameter setting processing based upon the additional information included in the signal.

3. The communication apparatus according to claim 2, wherein the signal is a probe response or beacon received from the apparatus as a response to transmission of a probe request.

4. The communication apparatus according to claim 1, further comprising a generating unit configured to generate the terminal identification information randomly whenever the communication-parameter setting processing is executed.

5. A communication system including a providing apparatus configured to provide communication parameters, and a receiving apparatus configured to execute communication-parameter setting processing with the providing apparatus and receive the communication parameters;
wherein when identification information has already been set, said providing apparatus transmits a signal inclusive of additional information indicative of this fact in a case where the start of communication-parameter setting processing using the identification information has been instructed; and
said receiving apparatus comprises:
a detection unit configured to detect, based upon receipt of the signal, one or a plurality of providing apparatuses which have been instructed to start communication-parameter setting processing using identification information and, moreover, in which this identification information has already been set;
an output unit configured to output terminal identification information; and
a setting control unit configured to execute the communication-parameter setting processing with a providing apparatus, which is other than an apparatus detected before the terminal identification information is output by said output unit, from among providing apparatuses detected by said detection unit.

6. A processing method of a communication apparatus, comprising:
detecting one or a plurality of already set apparatuses which have been instructed to start communication-parameter setting processing using identification information and, moreover, in which this identification information has already been set;
outputting terminal identification information; and
executing the communication-parameter setting processing with an already set apparatus other than an already set apparatus detected before the terminal identification information is output.

7. A non-transitory computer-readable storage medium storing a computer program for causing a computer, which is incorporated in a communication apparatus, to function as:
a detection unit configured to detect one or a plurality of already set apparatuses which have been instructed to start communication-parameter setting processing using identification information and, moreover, in which this identification information has already been set;
an output unit configured to output terminal identification information; and
a setting control unit configured to execute the communication-parameter setting processing with an already set apparatus other than an already set apparatus detected before the terminal identification information is output by the output unit.

8. A communication apparatus comprising:
a detection unit configured to detect one or a plurality of already set apparatuses which have been instructed to start communication-parameter setting processing using identification information and, moreover, in which this identification information has already been set;
an output unit configured to output terminal identification information; and
a setting control unit configured to execute the communication-parameter setting processing preferentially with an already set apparatus other than an already set apparatus detected before the terminal identification information is output by said output unit
